(19) United States
(12) Patent Application Publication
(10) Pub. No.: US 2015/0369398 A1
(43) Pub. Date: Dec. 24, 2015

(54) PNEUMATIC AND HYDRAULIC HOSE CLIP ASSEMBLY

(71) Applicant: Deere & Compnay, Moline, IL (US)

(72) Inventor: MYRNA YADIRA SAID, Guadalupe (MX)

(21) Appl. No.: 14/502,521

(22) Filed: Sep. 30, 2014

(30) Foreign Application Priority Data
Sep. 30, 2013 (DE) 102013219738.1

(51) Int. Cl. F16L 3/23; F16B 7/10; F16L 3/10

(52) U.S. Cl. CPC F16L 3/23; F16L 3/1091; F16B 7/105

(57) ABSTRACT

A clip assembly guides and fastens tubes and/or hoses on a frame structure. The clip assembly includes a first U-shaped clip and a second U-shaped clip. Each clip has two limbs. The limbs of the clips extend towards each other and telescopically engage each other or engage connecting rods which are positioned between the limbs.

### FIELD

The present disclosure relates to a hose routing clip assembly.

### BACKGROUND

Various hoses or fastening devices for guiding and fastening tubes and/or hoses on frame structures of, for example, agricultural machines or implements, in particular sowing machines or soil cultivation machines, are known in the prior art.

Known hoses normally have to be adapted to the number row units or functionality of the machine. This leads to a high number of different configurations on a machine or on a type of machine, which retentions systems varies depending on the machine configuration been adapted to the correspondingly required number and size of the tubes or hoses to be fastened. For example, a machine can need to fastened 2 hoses or 4 hoses depending on the configuration of it, for fastening two or four tubes or hoses is generally needed 2 different sizes of retention, this is suitable for fastening only two tubes or hoses or even five tubes or hoses on the frame structure with the same retention part number. This scenario is customary, for example, on planting machines or sowing machines or else other agricultural machines where one and the same frame structure is used for various models having different row units, that is to say having a different number of supply lines or supply tubes and supply cables.

Accordingly, it is desired to have a retention which is variable and can be used on as large a number of machines as possible.

### SUMMARY

According to an aspect of the present disclosure, the clip assembly includes a clip structure with a first U-shaped clip with two limbs or arms and a second U-shaped clip with two arms. The second clip is arranged opposite the first clip so that the limbs of the first clip face the limbs of the second clip, and the second clip is mounted telescopically to the first clip. The profile of the clips here can be angular or bent in a round manner. The clip cross section can be of angular or round. One clip is pushed telescopically into the other clip. Or, one clip can be slidable with respect to the other clip, so that the clips a slidably coupled together.

The first clip may have a tubular shape, i.e. can constitute a hollow member, wherein the second clip is guided in a telescopically displaceable manner in the first clip, and wherein the limbs of the first clip receive the limbs of the second clip. The hollow member preferably has a round profile, with a square profile also being able to be used.

Connecting bores can be formed on the limbs of the clips, wherein one of the clips has, on each of the limbs thereof, a multiplicity of connecting bores, by means of which the clips can be locked in a length-adjustable manner with respect to each other. Depending on the number of bores and the distance from one another, the size of the clip assembly can be adjusted more or less precisely. The connecting bores constitute passage bores on the clips, which passage bores are connectable to one another by a pin, bolt or a screw for locking and adjusting the size of the clip.

In an alternative embodiment, the first clip and the second clip are tubular, and connecting rods between the limbs telescopically receives the limbs. In this embodiment, the second clip is mounted in a displaceable or adjustable manner on the first clip via the connecting rods, and the connecting rods can be displaced telescopically both in the first and in the second clip.

In order to adjust the size of the clip assembly, connecting bores are formed on the limbs of the clips and on the connecting rods. One of the clips has, on each of the limbs thereof, or the connecting rods have, a multiplicity of connecting bores, by means of which the clips can be locked in a length-adjustable manner to each other. As described above, the connecting bores can also be connected by pins, bolts or screws.

A plurality of tubes or hoses of differing cross section and differing in number can be guided, laid and fastened on a frame structure. This can be done by using one or more of these retention assemblies, wherein the tubes and/or hoses are surrounded or held by the clips, and wherein at least one limb is mounted to a frame structure. The tubes or hoses are fastened on the frame structure by the clip assembly. The tubes or hoses are guided within the clip assembly and are enclosed or bundled by the clip assembly. The clip assembly can be adjusted and optimally set to the requirements depending on the number of tubes or hoses or on the size of same. One and the same clip assembly can thereby be used a plurality of times on the frame, in particular even if a tube strand or hose strand is divided or branched and, as a result, the number of tubes or hoses to be fastened on a frame part is reduced. The use of an identical component, here the identical clip assembly, means lower piece costs and less diversity of parts on the frame structure or on the machine.

The clip assembly can be welded to the frame structure. However, the clip assembly may be fixed to a frame member by a strap or a screw.

### BRIEF DESCRIPTION OF THE DRAWINGS

FIG. 1 is a schematic side view of a clip assembly in an extended position;

FIG. 2 is a schematic, perspective view of the clip assembly of FIG. 1;

FIG. 3 is a schematic side view of the clip assembly of FIG. 1 in a retracted position;

FIG. 4 is a schematic, perspective view of the clip assembly of FIG. 3;

FIG. 5 is a schematic side view of an alternative clip assembly in an extended position;

FIG. 6 is a schematic, perspective view of the clip assembly of FIG. 5;

FIG. 7 is a schematic side view of the clip assembly of FIG. 5 in a retracted position;

FIG. 8 is a schematic, perspective view of the clip assembly of FIG. 7;

FIG. 9 shows a side view of a detail of a frame structure with a clip assembly of FIG. 1; and

FIG. 10 is a side view of a detail of a frame structure with a clip assembly according to FIG. 3.

### DETAILED DESCRIPTION OF THE DRAWINGS

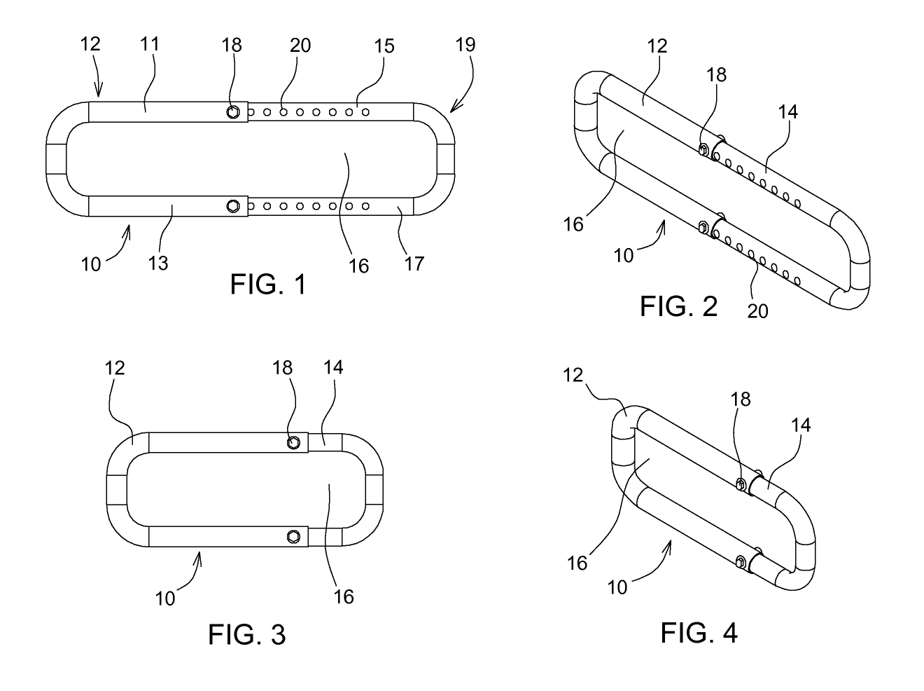

FIGS. 1 to 4 show a clip assembly 10 for guiding and fastening tubes and/or hoses on a frame structure. The clip assembly 10 has a first U-shaped clip 12 and a second U-shaped clip 14, wherein each clip has two limbs. Clip 12 has limbs or arms 11 and 13. Clip 14 has limbs or arms 15 and 17. Limbs 11 and 15 extend towards and are aligned with each other, and limbs 13 and 17 extend towards and are aligned with each other. The first clip 12 has a hollow or tubular shape. The second clip 14 may have a rod or a tubular shape. Both clips 12, 14 have a complimentary shape or cross-section, such as a circular cross section. The cross-sectional diameters of the two clips 12, 14 are dimensioned so that the second clip 14 has an outside diameter which is slightly smaller than the inside diameter of the tubular profile of the first clip 12, and therefore the limbs 15 and 17 of the second clip 14 can be inserted into the limbs 11 and 13 of the first clip 12, and the second clip 14 is guided or mounted telescopically in the first clip 12. The width of the clip assembly 10 and the area 16 surrounded by the clips 12, 14 depends on how far the second clip 14 is inserted into the first clip 12. The position of the second clip 14 in relation to the first clip 12 or how far the second clip 14 is inserted into the first clip can be determined and adjusted by connecting bores 18 on the first clip 12 and by a plurality of connecting bores 20 on the second clip 14. For this purpose, the connecting bores 20 on the second clip 14, which connecting bores are required for a desired size of the circumferential area 16 or for a certain adjustment dimension, are brought into alignment with the connecting bores 18 on the first clip 12 and connected by locking screws or locking pins. The clip assembly 10 can be more or less precisely adjusted depending on the number of connecting bores 20 formed on the second clip 14 and depending on the distance of said connecting bores from one another. FIGS. 1 and 2 show the clip assembly 10 in the extended state (which surrounds the largest possible area 16). FIGS. 3 and 4 show the clip assembly 10 in a retracted state, (which surrounds the smallest possible area 16). Intermediate positions can be set by a corresponding selection of the connecting bores 20 on the second clip 14.

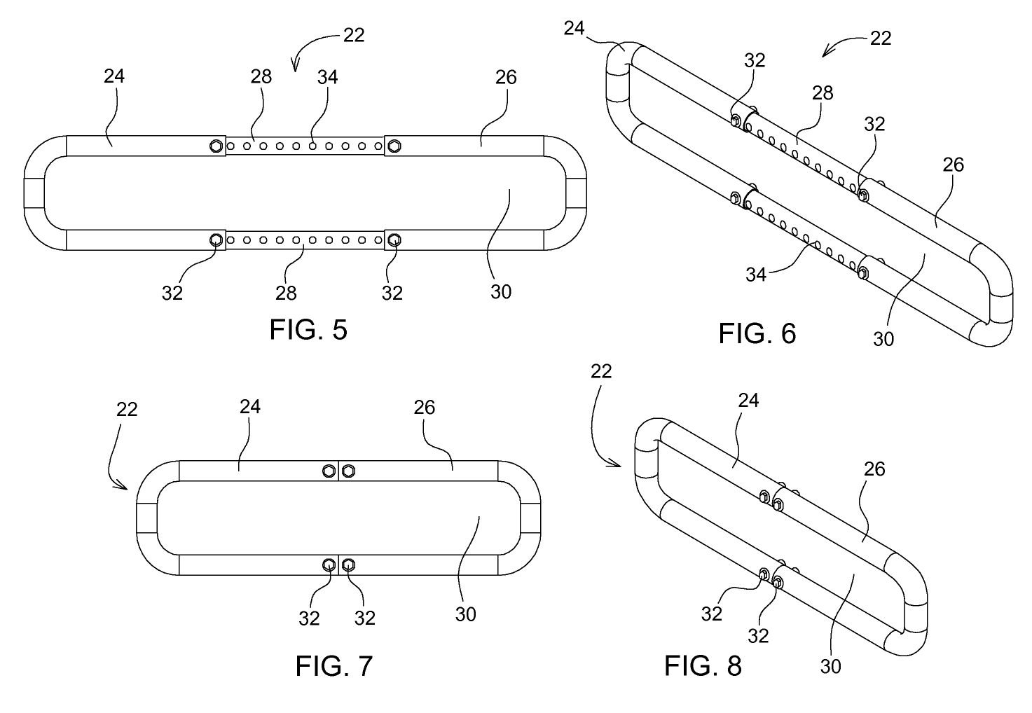

FIGS. 5 to 8 show an alternative embodiment of a clip assembly 22 for guiding and fastening tubes and/or hoses on a frame structure. The clip assembly 22 also has a first U-shaped clip 24 and a second U-shaped clip 26. Each clip has two limbs, and the clips 24, 26 are aligned with respect to each other in such a manner that the limbs of the first clip 24 extend towards the limbs of the second clip 26. The two clips 24, 26 are structurally identical. Both clips 24, 26 are hollow and tubular. clip assembly 22 also includes connecting rods 28, which may also be tubular. Both clips 24, 26 preferably have a circular cross sectional shape. The diameters of the two clips 24, 26 are such that the connecting rods 28 have an outside diameter which is slightly smaller than the inside diameter of the tubular profile of the clip 24, 26, so that one end of the connecting rods 28 are insertable into the limbs of the first clip 24, and the other ends are insertable into the limbs of the second clip 26. Thus, the second clip 26 is guided or mounted telescopically on the connecting rod 28 and is also guided or mounted telescopically in the first clip 24 via the connecting rod 28. The width of the clip assembly 22 or area 30 surrounded by the clips 24, 26 is dependent on how far the connecting rods 28 are retracted into the first clip 24 and the second clip 26. The position of the second clip 26 in relation to the first clip 24 or the extent to which the connecting rods are retracted into the first and second clips 24, 26 can be determined and adjusted by connecting bores 32 on the first and on the second clip 24, 26 and by a plurality of connecting bores 34 on the connecting rods. For this purpose, the connecting bores 34 on the connecting rods 28, which connecting bores are required for a desired size of the circumferential area 30 or for a certain adjustment dimension, are brought into alignment with the connecting bores 32 on the first and second clips 24, 26 and are connected by locking screws or locking pins. The clip assembly 22 can be more or less precisely adjusted depending on the number of connecting bores 34 formed on the connecting rods and depending on the distance of said connecting bores from one another. While FIGS. 5 and 6 both show the clip assembly 22 in the extended state (in which the greatest possible area 30 is surrounded). FIGS. 7 and 8 show a contrasting example, in which the clip assembly 22 is shown in a retracted state (in which the smallest possible area 30 is surrounded). Intermediate positions can be set by a corresponding choice of the connecting bores 34 on the connecting rods 28.

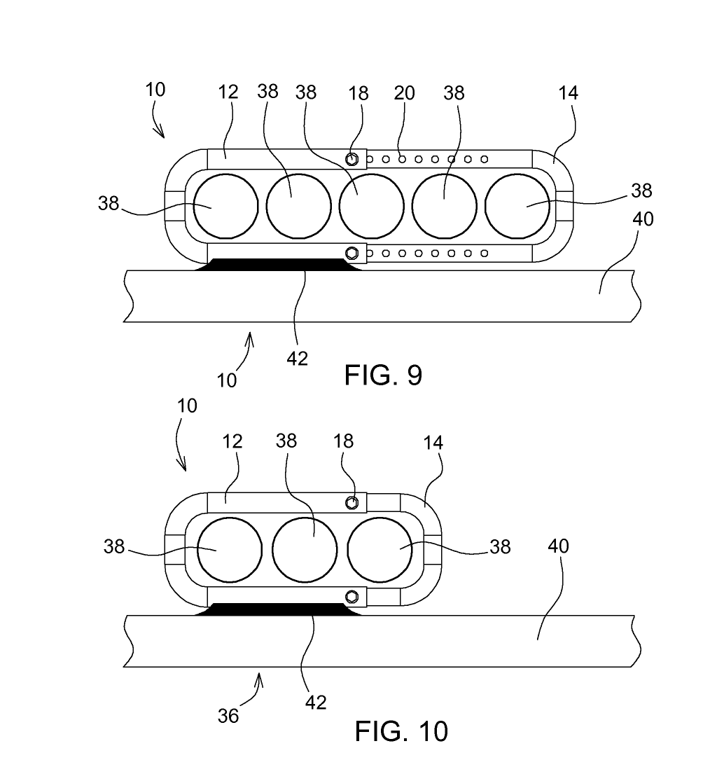

FIGS. 9 and 10 both show the clip assembly 10 from FIGS. 1 to 4 mounted by weld seam 42 to a frame structure 36 for and holding or guiding tubes and/or hoses 38. Referring to FIG. 9, the clip assembly 10 is extended and holds five tubes and/or hoses 38. In FIG. 10, the clip assembly 10 is retracted and holds only three tubes and/or hoses 38. In the two examples, the first clip 12 is welded to a frame part 40 of the frame structure 36. Since only the first clip 12 is welded to the frame part 40, the second clip 14 can continue to be telescopically adjusted. The same would also apply to a frame structure 36 with a clip assembly 22 according to FIGS. 5 to 8, wherein the first clip 24 could be welded to the frame part 40, and the connecting rods 28 or the second clip 26 can be telescopically adjustable in relation to the first clip 24.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

What is claimed is:

1. A clip assembly for guiding and holding tubes and/or hoses on a frame structure, characterized by:
a first U-shaped clip having a two limbs;
a second U-shaped clip having two limbs, the limbs of the first clip extending towards the limbs of the second clip, and the second clip is mounted telescopically to the first clip.

2. The clip assembly of claim 1, wherein:
the first clip is tubular and the second clip is guided in a telescopically displaceable manner in the first clip.

3. The clip assembly of claim 1, wherein:
the limbs of the clips include a plurality of connecting bores so that the clips can be coupled together in a length-adjustable manner.

4. The clip assembly of claim 1, wherein:
the first clip and the second clip are tubular; and
connecting rods are arranged between the limbs and slidably and telescopically engage the limbs.

5. The clip assembly of claim 4, wherein:
the limbs include connecting bores formed therein; and
the connecting rods include a plurality of connecting bores formed therein, so that the limbs and the connecting rods can be coupled together in a length-adjustable manner.

6. The clip assembly of claim 1, wherein:
a limb of one of the clips is mounted to a frame structure; and
the clip assembly guides a plurality of tubes and/or hoses.

7. The clip assembly of claim 6, wherein:
a limb of one of the clip is welded to the frame structure.
